(19) United States
(12) Patent Application Publication
(10) Pub. No.: US 2026/0264146 A1
(43) Pub. Date: Sep. 10, 2026

(54) METHOD FOR FEEDING MATERIAL INTO PLASMA FOR SPHEROIDIZATION

(71) Applicant: Agency for Science, Technology and Research, Singapore (SG)

(72) Inventors: Verner SOH, Singapore (SG); Delvin WUU, Singapore (SG); Pei WANG, Singapore (SG)

(73) Assignee: Agency for Science, Technology and Research, Singapore (SG)

(21) Appl. No.: 19/167,796

(22) PCT Filed: Mar. 22, 2024
(86) PCT No.: PCT/SG2024/050170

§ 371 Date: Sep. 22, 2025

(30) Foreign Application Priority Data
Mar. 23, 2023 (SG) 10202300785U

(51) Int. Cl. B22F 9/14; B22F 1/065

(52) U.S. Cl. CPC B22F 9/14; B22F 1/065

(57) ABSTRACT

There is provided a method for producing a spheroidized powder from a feed stream comprising metal powder, the method comprising feeding a first feed stream comprising metal powder into a plasma chamber at a first angle offset from plasma flow within the plasma chamber; and melting and spheroidizing the metal powder within the plasma chamber to form spheroidized powder, wherein the first angle offset from plasma flow is in a direction against the plasma flow. There is also provided a nozzle for feeding a feed stream into a plasma chamber.

### TECHNICAL FIELD

The present invention relates to an improved method for feeding material into plasma for spheroidization.

### BACKGROUND

With the increase of use of 3D printing, there is a huge amount of waste metal powders generated from metal 3D printing processes such as laser directed energy deposition (LDED), laser powder bed fusion (LPBF), since the reuse of waste powder from 3D printing cannot be used in the 3D printing process directly as it would degrade the parts. Therefore, it would be necessary to convert the waste metal powders at least from 3D printing or general metal waste into metal powder which can be re-used.

Currently available recycling methods and devices are designed for wire and/or rod as feedstock for powder atomization, and is unable to process powdery feedstock material. There is also limited flexibility in customising the composition of the recycled material.

There is therefore a need for an improved method for processing powdery feedstock material.

### SUMMARY OF THE INVENTION

The present invention seeks to address these problems, and/or to provide an improved method for feeding metal powder material into plasma for spheroidization.

According to a first aspect, the present invention provides a method for producing a spheroidized powder from a feed stream comprising metal powder, the method comprising:
feeding a first feed stream comprising metal powder into a plasma chamber at a first angle offset from plasma flow within the plasma chamber; and
melting and spheroidizing the metal powder within the plasma chamber to form spheroidized powder,
   wherein the first angle offset from plasma flow is in a direction against the plasma flow.

The method may further comprise feeding a second feed stream comprising metal powder into the plasma chamber at a second angle offset from plasma flow within the plasma chamber, prior to the melting and spheroidizing.

According to a particular aspect, first angle may be 0° to 90° relative to plasma flow.

According to a particular aspect, the second angle may be 0° to 90° relative to plasma flow.

The method may further comprise simultaneously providing at least one coaxial airflow respective to a flow of the metal powder with the feeding a first feed stream and/or feeding a second feed stream.

The method may further comprise sequentially providing at least one coaxial airflow respective to a flow of the metal powder with the feeding a first feed stream and/or feeding a second feed stream.

The metal powder comprised in the first feed stream may be the same or different from the metal powder comprised in the second feed stream.

According to a particular aspect, the feeding a first feed stream may comprise flowing the metal powder in a plurality of metal powder streams. Each of the plurality of metal powder streams may comprise a different type of metal powder. The flowing may comprise converging each of the plurality of metal powder streams at an angle between 0° to 90° in the plasma chamber.

According to a particular aspect, the feeding a second feed stream may comprise flowing the metal powder in a plurality of metal powder streams. Each of the plurality of metal powder streams may comprise a different type of metal powder. The flowing may comprise converging each of the plurality of metal powder streams at an angle between 0° to 180° in the plasma.

According to a particular aspect, the melting and spheroidizing the metal powder may be carried out in an inert environment.

According to a particular aspect, the second angle offset from plasma flow may be in a direction against the plasma flow.

According to a second aspect, there is provided a nozzle for feeding a feed stream into a plasma chamber, the nozzle comprising:
an inlet adapted to receive a metal powder;
an outlet adapted to feed the metal powder into a plasma chamber; and
a plurality of channels between the inlet and the outlet, adapted to flow the metal powder from the inlet to the outlet,
   wherein the plurality of channels are arranged at a converging angle towards the outlet.

According to a particular aspect, the nozzle may comprise at least one airflow channel surrounding the plurality of channels. The at least one airflow channel may be arranged coaxially relative to the plurality of channels. The converging angle may be between 0° to 90° relative to each of the plurality of channels.

According to a particular aspect, the nozzle may comprise at least one airflow channel arranged between the plurality of channels. The converging angle may be between 0° to 180° relative to each of the plurality of channels.

Each of the plurality of channels may have a width of 0.5 to 20 mm.

The at least one airflow channel may have a width of 0.1 to 10 mm.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows an example of a powder feeder module;

FIG. 2 shows a schematic of a method for producing a spheroidized powder from a feed stream comprising metal powder;

FIG. 3 shows SEM images of waste metal powder generated from 3D printing, before (left) and after (right) spheroidization treatment;

FIG. 4 shows a bar graph of Hall flow test results of waste metal powder after spheroidization treatment;

FIG. 5 shows SEM images of mechanically pre-alloyed metal powders, before (left) and after (right) spheroidization treatment;

FIG. 6 shows a bar graph of Hall flow test results of mechanically pre-alloyed metal powders after spheroidization treatment;

FIG. 7 shows a schematic diagram of an embodiment of a nozzle for feeding a feed stream into a plasma chamber;

FIG. 8 shows a schematic cross-section of the embodiment of the nozzle of FIG. 7;

FIG. 9 shows a schematic diagram of an alternate embodiment of a nozzle for feeding a feed stream into a plasma chamber; and

FIG. 10 shows a schematic cross-section of the embodiment of the nozzle of FIG. 9.

### DETAILED DESCRIPTION

As explained above, there is a need for an improved method for processing powdery feedstock material.

In general terms, the present invention provides a method for producing a spheroidized powder from a feed stream comprising metal powder. The method may properly angle the flow of the input powder directly into a plasma flow, thereby enabling powdery feedstock material to be spheroidized directly without the need for pre-processing into wires and/or rods.

According to a first aspect, the present invention provides a method for producing a spheroidized powder from a feed stream comprising metal powder, the method comprising:
feeding a first feed stream comprising metal powder into a plasma chamber at a first angle offset from plasma flow within the plasma chamber; and
melting and spheroidizing the metal powder within the plasma chamber to form spheroidized powder,
   wherein the first angle offset from plasma flow is in a direction against the plasma flow.

For the purposes of the present invention, the use of the singular includes the plural unless specifically stated otherwise. It should be noted that, as used in the specification and the appended claims, the singular forms “a”, “an” and “the” include plural referents unless the context clearly dictates otherwise. Further, the use of the term “including”, “comprising”, and “having” as well as other forms, such as “include”, “comprise”, “have” are not considered limiting.

For the purposes of the present invention, references to a spheroidized powder refers to dry, bulk solid composed of fine particles with an average degree of sphericity of 0.8 to 1.0.

According to a particular aspect, the spheroidized powder may comprise a particle diameter of 20-500 μm. The spheroidized powder may have any suitable shape and may have a degree of deviation that is sufficiently small so as to not measurably detract from identifying the shape as a sphere. For example, the spheroidized powder may have circular symmetry. In particular, the spheroidized powder may have an average sphericity, which is the ratio of the surface area of an equal-volume sphere to the actual surface area of the particle, of 0.8 to 1.0. Even more in particular, the spheroidized powder may have an average sphericity of 0.95 to 1.0 For example, the spheroidized powder may have shapes of a sphere, an oblate, a prolate, or any combination thereof.

The feed stream may comprise suitable metal powder. For example, the metal powder may comprise metallic powder, pre-alloyed powder, alloyed powder, or a combination thereof. In particular, the metal powder may comprise angular powder, an irregular powder, or a sponge powder.

The metal powder may comprise any suitable composition, and may include non-metal additives. For example, the metal powder may comprise iron, cobalt, nickel, chromium, carbon, copper, aluminium, gold, silver, titanium, vanadium, manganese, zinc, molybdenum, tungsten, or any combination thereof.

The feeding a first feed stream comprising metal powder may be at any suitable speed. For example, the feeding a first feed stream may be at 0.1 L/min to 5 L/min. In particular, the feeding a first feed stream may be at 0.5 L/min to 4.5 L/min, 1 L/min to 4 L/min, 1.5 L/min to 3.5 L/min, 2 L/min to 3 L/min. Even more in particular, the feeding a first feed stream may be at 0.5 L/min to 1.5 L/min.

The feeding a first feed stream comprising metal powder may be at any suitable first angle offset from plasma flow within the plasma chamber, and may be in any direction against the plasma flow. The first angle offset may advantageously allow sufficient contact time between the powder and the plasma, such that the powder melts and forms spherical shapes due to surface tension. The direction against the plasma flow may advantageously allow the powder to be suspended in the plasma for a longer time, thereby improving spheroidization. For example, the first angle offset may be 0° to 90° relative against plasma flow. In particular, the first angle offset may be 5° to 85°, 10° to 80°, 15° to 75°, 20° to 70°, 25° to 65°, 30° to 60°, 35° to 55°, 40° to 50°, relative against plasma flow. Even more in particular, the first angle offset may be 45°. The powder may flow through the plasma at any suitable flow rate to allow sufficient contact time between the powder and the plasma. For example, the powder may flow through the plasma at a flow rate of 0.1 L/min to 5 L/min. In particular, the flow rate may be 0.5 L/min to 4.5 L/min, 1 L/min to 4 L/min, 1.5 L/min to 3.5 L/min, 2 L/min to 3 L/min. Even more in particular, the flow rate may be 0.5 L/min to 1.5 L/min. The contact time may be 0.2 to 0.4 seconds.

The plasma flow may be generated by any suitable means. For example, the plasma flow may be generated from a plasma torch. The plasma flow generated from a plasma torch may be generated by direct current (DC), alternating current (AC), radio-frequency (RF), or any other suitable discharges. The plasma flow may be generated at any suitable current to enable the metal powder to melt and spheroidize. For example, the current may be 130 A to 180 A. In particular, the current may be 140 A to 150 A. Even more in particular, the current may be 150 A.

The melting and spheroidizing the metal powder within the plasma chamber may be at any suitable temperature and time to enable the metal powder to melt and spheroidize. For example, the melting and spheroidizing may be at a temperature of 650-3000° C. In particular, the melting and spheroidizing may be at a temperature of 700-2900° C., 800-2800° C., 900-2700° C., 1000-2600° C., 1100-2500° C., 1200-2400° C., 1300-2300° C., 1400-2200° C., 1500-2100° C., 1600-2000° C., 1700-1900° C. Even more in particular, the melting and spheroidizing may be at a temperature of 1200-1800° C.

The method may advantageously be used to recycle metal waste, for example, but not limited to, waste metal powder from additive manufacturing and metal scraps. Further, the method may allow for increased production efficiency of powders from mechanically pre-alloyed metals.

According to a particular aspect, the method may further comprise feeding a second feed stream comprising metal powder into the plasma chamber at a second angle offset from plasma flow within the plasma chamber, prior to the melting and spheroidizing.

The feeding a second feed stream comprising metal powder may be at any suitable second angle offset from plasma flow within the plasma chamber. The second angle offset may advantageously allow sufficient contact time between the powder and the plasma, such that the powder melts and forms spherical shapes due to surface tension. For example, the second angle offset may be 0° to 90° relative to plasma flow. In particular, the second angle offset may be 5° to 85°, 10° to 80°, 15° to 75°, 20° to 70°, 25° to 65°, 30° to 60°, 35° to 55°, 40° to 50°, relative to plasma flow. Even more in particular, the second angle offset may be 45°. The powder may flow through the plasma at any suitable flow rate to allow sufficient contact time between the powder and the plasma. For example, the powder may flow through the plasma at a flow rate of 0.1 L/min to 5 L/min. In particular, the flow rate may be 0.5 L/min to 4.5 L/min, 1 L/min to 4 L/min, 1.5 L/min to 3.5 L/min, 2 L/min to 3 L/min. Even more in particular, the flow rate may be 0.5 L/min to 1.5 L/min. For example, the contact time may be 0.2-0.4 seconds.

The feeding a second feed stream may be simultaneous or sequential with the feeding a first feed stream. In this way, the method advantageously allows a single-step alloying and atomisation process, thereby allowing the user to easily customise the composition of the end-product without a pre-alloying step.

The feeding a second feed stream comprising metal powder may be at any suitable speed. For example, the feeding a second feed stream may be at 0.1 L/min to 5 L/min. In particular, the feeding a second feed stream may be at 0.5 L/min to 4.5 L/min, 1 L/min to 4 L/min, 1.5 L/min to 3.5 L/min, 2 L/min to 3 L/min. Even more in particular, the feeding a second feed stream may be at 0.5 L/min to 1.5 L/min.

The second feed stream may comprise any suitable metal powder. For example, the metal powder may comprise metallic powder, pre-alloyed powder, alloyed powder, or a combination thereof. In particular, the metal powder may comprise angular powder, an irregular powder, or a sponge powder.

The metal powder may comprise any suitable composition, and may include non-metal additives. For example, the metal powder may comprise iron, cobalt, nickel, chromium, carbon, copper, aluminium, gold, silver, titanium, vanadium, manganese, zinc, molybdenum, tungsten, or any combination thereof.

According to a particular aspect, the method may further comprise simultaneously providing at least one coaxial airflow respective to a flow of the metal powder with the feeding a first feed stream and/or feeding a second feed stream.

According to another particular aspect, the method may further comprise sequentially providing at least one coaxial airflow respective to a flow of the metal powder with the feeding a first feed stream and/or feeding a second feed stream.

The at least one coaxial airflow may be at any suitable airflow speed. For example, the at least one coaxial airflow may be at 0.1 L/min to 5 L/min. In particular, the at least one coaxial airflow may be at 0.5 L/min to 4.5 L/min, 1 L/min to 4 L/min, 1.5 L/min to 3.5 L/min, 2 L/min to 3 L/min. Even more in particular, the at least one coaxial airflow may be at 0.5 L/min to 1.5 L/min. The at least one coaxial airflow may comprise any suitable gas. For example, the at least one coaxial airflow may comprise argon, helium, nitrogen, or any combination thereof.

The providing of at least one coaxial airflow concentrates the powder into a compact cone, reducing particle spread and thereby increasing the amount of powder in contact with the plasma flow, which advantageously increases output of spheroidized powder.

According to a particular aspect, the metal powder comprised in the first feed stream may have the same or different from the metal powder comprised in the second feed stream. For example, the metal powder comprised in the first feed stream may have the same or different particle size, particle distribution, composition as the metal powder comprised in the second feed stream.

According to a particular aspect, the feeding a first feed stream may comprise flowing the metal powder in a plurality of metal powder streams. The flowing the metal powder in a plurality of metal powder streams allows flexibility in choosing the type of metal powder for each of the plurality of metal powder streams.

The each of the plurality of metal powder streams may comprise a different type of metal powder. This advantageously allows a single-step alloying and atomisation process, thereby allowing the user to easily customise the composition of the end-product without a pre-alloying step. The number of metal powder streams may be customised according to the desired end-product.

The flowing the metal powder in a plurality of metal powder streams may comprise converging each of the plurality of metal powder streams at an angle between 0° to 90° in the plasma chamber. In particular, the converging each of the plurality of metal powder streams may be at an angle between 5° to 85°, 10° to 80°, 15° to 75°, 20° to 70°, 25° to 65°, 30° to 60°, 35° to 55°, 40° to 50°. Even more in particular, the converging may be at 45°. The converging advantageously promotes efficient collision and uniform heating, which is particularly useful in forming alloys.

According to a particular aspect, the feeding a second feed stream may comprise flowing the metal powder in a plurality of metal powder streams. The flowing the metal powder in a plurality of metal powder streams allows flexibility in choosing the type of metal powder for each of the plurality of metal powder streams. The number of metal powder streams may be customised according to the desired end-product.

The each of the plurality of metal powder streams may comprise a different type of metal powder. Thus, there may be feeding a first feed stream and feeding a second feed stream, and each may comprise flowing the metal powder in a plurality of metal powder streams. This advantageously allows a scale-up of a single-step alloying and atomisation process, thereby allowing efficient and customisable forming of powdered multi-elemental alloys.

The flowing the metal powder in a plurality of metal powder streams may comprise converging each of the plurality of metal powder streams at an angle between 0° to 180° in the plasma chamber. In particular, the converging each of the plurality of metal powder streams may be at an angle between 5° to 175°, 10° to 170°, 15° to 165°, 20° to 160°, 25° to 150°, 30° to 145°, 35° to 140°, 40° to 135°, 45° to 130°, 50° to 125°, 55° to 120°, 60° to 115°, 65° to 110°, 70° to 105°, 75° to 100°, 80° to 95°, 85° to 90°. Even more in particular, the converging may be at 90°. The converging advantageously promotes efficient collision and uniform heating, which is particularly useful in forming alloys.

According to a particular aspect, the melting and spheroidizing the metal powder may be carried out in an inert environment to avoid oxidation of the spheroidized powder. For example, the melting and spheroidizing the metal powder may be carried out in an atmosphere of argon, helium, nitrogen, or any combination thereof.

The formed spheroidized powder may comprise a particle diameter of 20-500 μm. In particular, the formed spheroidized powder may comprise a particle diameter of 50-450 μm, 100-400 μm, 150-350 μm, 200-300 μm. Even more in particular, the formed spheroidized powder may comprise a particle diameter of 20-150 μm.

According to a particular aspect, the second angle offset from plasma flow may be in a direction against the plasma flow. In this way, metal powder from the feed stream is fed against the plasma flow, which allows increased contact time between the powder and the plasma and advantageously leads to increased output.

According to a second aspect, there is provided a nozzle for feeding a feed stream into a plasma chamber, the nozzle comprising:
an inlet adapted to receive a metal powder;
an outlet adapted to feed the metal powder into a plasma chamber; and
a plurality of channels between the inlet and the outlet, adapted to flow the metal powder from the inlet to the outlet,
   wherein the plurality of channels are arranged at a converging angle towards the outlet.

The inlet may be adapted for receiving a metal powder. The inlet may have any suitable size. For example, the inlet may have a width of 0.5-100 mm. In particular, the inlet may have a width of 1-95 mm, 2-90 mm, 3-85 mm, 4-80 mm, 5-75 mm, 10-70 mm, 15-65 mm, 20-60 mm, 25-55 mm, 30-50 mm, 35-45 mm. Even more in particular, the inlet may have a width of 3-10 mm. The metal powder may be as described above. The outlet may be adapted for feeding the metal powder into a plasma chamber. The outlet may have any suitable size. For example, the outlet may have a width of 0.5-100 mm. In particular, the outlet may have a width of 1-95 mm, 2-90 mm, 3-85 mm, 4-80 mm, 5-75 mm, 10-70 mm, 15-65 mm, 20-60 mm, 25-55 mm, 30-50 mm, 35-45 mm. Even more in particular, the outlet may have a width of 3-10 mm.

The plurality of channels between the inlet and the outlet may be adapted for flowing the metal powder from the inlet to the outlet. Each of the plurality of channels may have any suitable size. For example, each of the plurality of channels may have a width of 0.5 to 20 mm. In particular, each of the plurality of channels may have a width of 1 to 19 mm, 2 to 18 mm, 3 to 17 mm, 4 to 16 mm, 5 to 15 mm, 6 to 14 mm, 7 to 13 mm, 8 to 12 mm, 9 to 11 mm. Even more in particular, each of the plurality of channels may have a width of 3 to 5 mm.

Each of the plurality of channels may have the same size or different size, and may contain the same or different metal powders. In this way, when different metal powders are used, these may pass through each of the plurality of channels at different flow rates, thus allowing easy customisation of different alloys and decreasing or even eliminating downtime required to change powders when a different alloy is desired.

The metal powders may flow through the plurality of channels at any suitable flow rate. For example, the flow rate may be 0.1 L/min to 5 L/min. In particular, the flow rate may be 0.5 L/min to 4.5 L/min, 1 L/min to 4 L/min, 1.5 L/min to 3.5 L/min, 2 L/min to 3 L/min. Even more in particular, the flow rate may be 0.5 L/min to 1.5 L/min.

The plurality of channels may be arranged at a converging angle towards the outlet. The converging angle towards the outlet advantageously promotes efficient collision and uniform heating, which is particularly useful in forming alloys.

According to a particular aspect, the nozzle may comprise at least one airflow channel surrounding the plurality of channels. The at least one airflow channel may be of any suitable size. For example, the at least one airflow channel may have a width of 0.1-10 mm. In particular, the at least one airflow channel may have a width of 1-9 mm, 2-8 mm, 3-7 mm, 4-6 mm. Even more in particular, the at least one airflow channel may have a width of 1-4 mm.

The at least one airflow channel may be arranged coaxially relative to the plurality of channels. The at least one airflow channel arranged coaxially relative to the plurality of channels concentrates the metal powder into a compact cone, and when in use, reduces particle spread and thereby increases the amount of powder in contact with the plasma flow, which advantageously increases output of spheroidized powder.

According to a particular aspect, the converging angle towards the outlet may be between 0° to 90° relative to each of the plurality of channels. In particular, the converging angle may be between 5° to 85°, 10° to 80°, 15° to 75°, 20° to 70°, 25° to 65°, 30° to 60°, 35° to 55°, 40° to 50°. Even more in particular, the converging angle may be 45°. The converging angle advantageously leads to efficient collision and uniform heating of the metal powder, which is particularly useful in forming alloys.

According to another particular aspect, the nozzle may comprise at least one airflow channel arranged between the plurality of channels. The at least one airflow channel may be of any suitable size. For example, the at least one airflow channel may have a width of 0.1-10 mm. In particular, the at least one airflow channel may have a width of 1-9 mm, 2-8 mm, 3-7 mm, 4-6 mm. Even more in particular, the at least one airflow channel may have a width of 1-4 mm. In this aspect, the converging angle towards the outlet may be between 0° to 1800 relative to each of the plurality of channels. In particular, the converging angle may be between 5° to 175°, 10° to 170°, 15° to 165°, 20° to 160°, 25° to 150°, 30° to 145°, 35° to 140°, 40° to 135°, 45° to 130°, 50° to 125°, 55° to 120°, 60° to 115°, 65° to 110°, 70° to 105°, 75° to 100°, 80° to 95°, 85° to 90°. Even more in particular, the converging angle may be 90°. The converging angle advantageously leads to efficient collision and uniform heating of the metal powder, which is particularly useful in forming alloys.

An example of the nozzle may comprise a tubular inner channel and one or more ring-shaped outer channels, with a radially symmetrical cross-section, and a converging angle towards the outlet.

According to a particular aspect, the nozzle as described above may be comprised in a nozzle assembly for scaling up the feeding a feed stream into a plasma chamber.

Having now generally described the invention, the same will be more readily understood through reference to the following example which is provided by way of illustration, and is not intended to be limiting.

### Example 1

### Materials and Methods

Waste stainless steel (SS316L) powder from additive manufacturing (LENS 3D printer) were obtained. The powder was a waste product produced by gas atomisation after 3D printing, and contained a mixture of melted powders, partially melted powders, and powders produced from splashes during the additive manufacturing process. The powders were used as-is without any pre-treatment.

A plasma chamber was set up using a plasma torch with a sharpened tungsten tip, at a current of 150 A. Argon atmosphere was used in the plasma chamber.

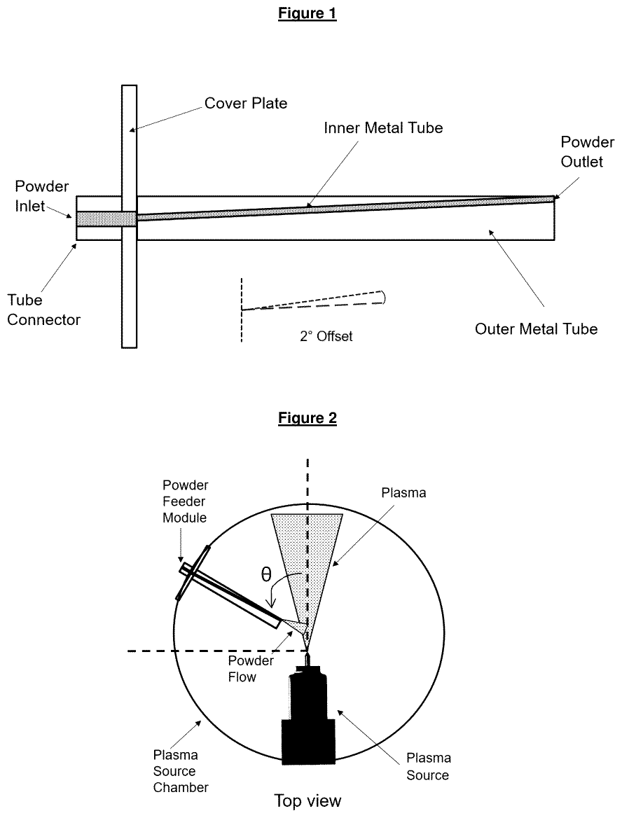

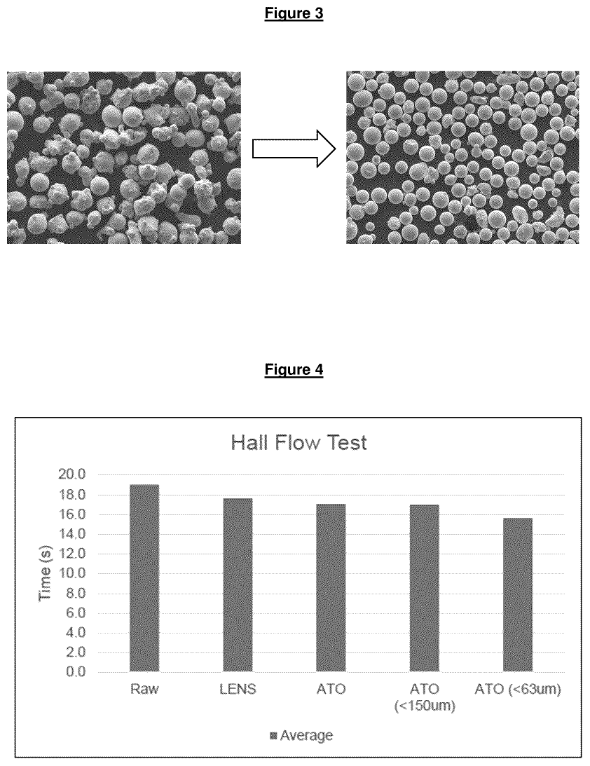

A powder feeder module was set up with a tube connector (10 mm diameter) attached to a powder feeder, as shown in FIG. 1. The inner tube had a length of 130 mm and a diameter of 4 mm, and was angled at 2° such that the powder flows directly from the outlet and into the plasma source. The powder was fed through the inner tube with an argon flow rate of 1 L/min, with the module angled at 45° against the flow of plasma, as shown in FIG. 2. The powder flow rate through the inner tube was 1 L/min. As the powder came into contact with the plasma, it was melted and spheroidized due to surface tension, and the spheroidized powder was blown into a collector.

### Characterisation

Scanning electron microscope (SEM) imaging was performed on the waste powder before and after spheroidization. SEM imaging was performed with JEOL JSM7600F at 100× magnification, 15 Kv, LM mode with a working distance of 15.0 mm.

The treated powders were also analysed using the Hall Flow test. Hall Flow test was done using Hall Flowmeter funnel where 50 g of powder was timed as it flowed through a calibrated orifice of the Hall Flowmeter funnel. An average of 3 results was tabulated.

### Results and Discussion

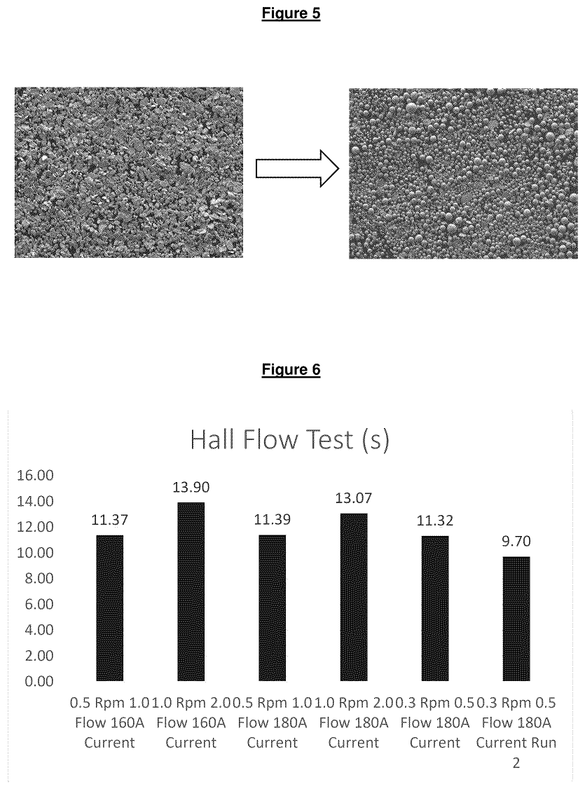

As seen in FIG. 3 (left), the untreated powders had irregular shapes and uneven morphologies, which lead to inferior quality of 3D printed parts if used. After spheriodization, the powders showed an obvious improvement in regular spheroid shapes and smooth morphologies, as seen in FIG. 3 (right). More than 95% of the powders fed were successfully spheroidized.

There were also fewer powder satellites compared to prior art methods of powder processing, such as gas atomisation. The treated powders ranged in sizes of 20-150 μm.

The Hall flow test results are shown in FIG. 4 and Table 1.

TABLE 1
Hall flow test with 50 g of treated waste powder

| | Raw | LENS | ATO | ATO (<150 μm) | ATO (<63 μm) |
|---|---|---|---|---|---|
| Test 1 | 19.0 | 17.6 | 17.0 | 17.0 | 15.6 |
| Test 2 | 19.0 | 17.7 | 16.9 | 16.9 | 15.6 |
| Test 3 | 19.0 | 17.5 | 17.2 | 17.0 | 15.6 |
| Average | 19.0 | 17.6 | 17.0 | 17.0 | 15.6 |

A shorter time indicated by the Hall Flow results shows that the powder after spheroidization (ATO, ATO (<150 μm), ATO (<63 μm)) had improved flowability compared to the raw powder and the waste powder obtained from LENS 3D printer. Powders with shorter Hall Flow results indicated better flowability, and hence a better spread of powder during additive manufacturing, and leads to printed parts with desired lower porosity.

### Example 2

### Materials and Methods

Iron (Fe), cobalt (Co), and nickel (Ni) powders were mechanically pre-alloyed. Mechanical alloying was performed with Fritsch Pulverisette 6 classic line. 50 g of Fe, Co and Ni mixture (in equal weight proportions) and 250 g of balls were prepared in a milling jar. The mixture was then ball milled at 200 rpm with intervals of 5 minutes milling and 5 minutes rest time, for a total milling time of 5 hours.

The plasma chamber and powder feeder module were set up and the spheroidization process of the mechanically pre-alloyed powder was carried out as described in Example 1.

### Characterisation

Scanning electron microscope (SEM) imaging was performed on the waste powder before and after spheroidization as described in Example 1.

The treated powders were also analysed using the Hall flow test as described in Example 1.

### Results and Discussion

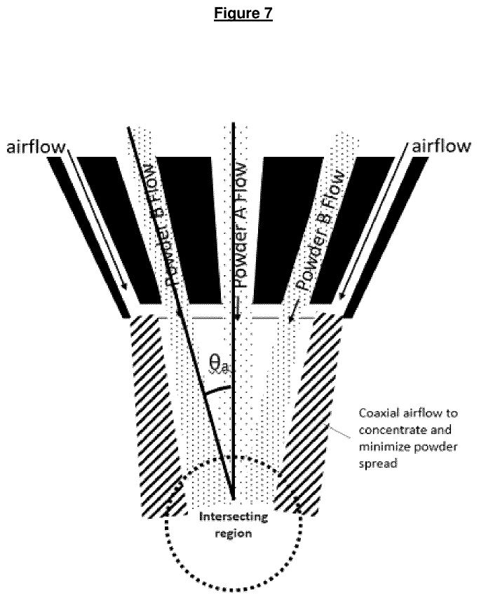

As seen in FIG. 5 (left), the untreated powders had flaky and flat appearances, as expected from ball milling since the powders were constantly impacted at high force.

After spheroidization, as seen in FIG. 5 (right), the powders became spherical in shape, indicating successful spheroidization process. More than 95% of the powders fed were successfully spheroidized.

The Hall flow test results are shown in FIG. 6 and Table 2.

TABLE 2
Hall flow test with 50 g of treated pre-alloyed powder

| | | | | | Current 180A | Current 180A |
|---|---|---|---|---|---|---|
| | Current 160A | | Current 180A | | (Slower Rate) | (Rerun) |
| | 0.5 RPM | 1.0 RPM | 0.5 RPM | 1.0 RPM | 0.3 RPM | 0.5 RPM |
| | 1.0 Flow | 2.0 Flow | 1.0 Flow | 2.0 Flow | 0.5 Flow | 1.0 Flow |
| | 160A Current | 160A Current | 180A Current | 180A Current | 180A Current | 180A Current |
| Test 1 | 11.40 | 13.82 | 11.49 | 13.10 | 11.21 | 9.80 |
| Test 2 | 11.38 | 13.85 | 11.18 | 13.05 | 11.42 | 9.70 |
| Test 3 | 11.33 | 14.03 | 11.49 | 13.05 | 11.34 | 9.60 |
| Average | 11.37 | 13.90 | 11.39 | 13.07 | 11.32 | 9.70 |

As seen from Table 2, FeCoNi powder with better flowability can be obtained with a slower flow rate. Increasing the current at a slower flow rate did not affect the flowability. It is likely that the alloy powder had already melted at the lower current (160 A), and thus increasing the current did not affect the powder flowability. When the spheroidised powder were subject to a rerun of the spheroidization process, a 14% improvement in flow rate can be achieved.

### Example 3

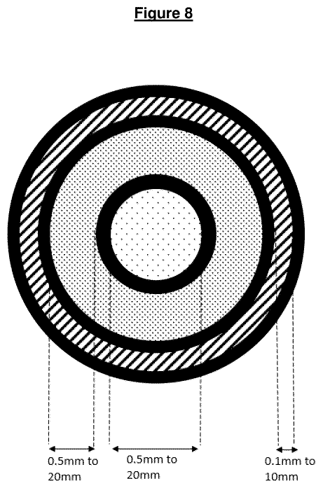

An example of a nozzle is as shown in FIG. 7, and the cross-section of the nozzle is shown in FIG. 8. Three channels for flowing metal powder were arranged between an inlet and an outlet. The three channels were angled in a converging manner towards the outlet. Powder A flowed through the central channel while Powder B flowed through the remaining two channels.

A coaxial airflow channel surrounding the three channels was formed. Argon was flowed through the airflow channel at 1 L/min.

Powders A and B converged within the plasma at an angle of 0°>θₐ>90° to form an alloy, and the airflow minimised powder spread.

### Example 4

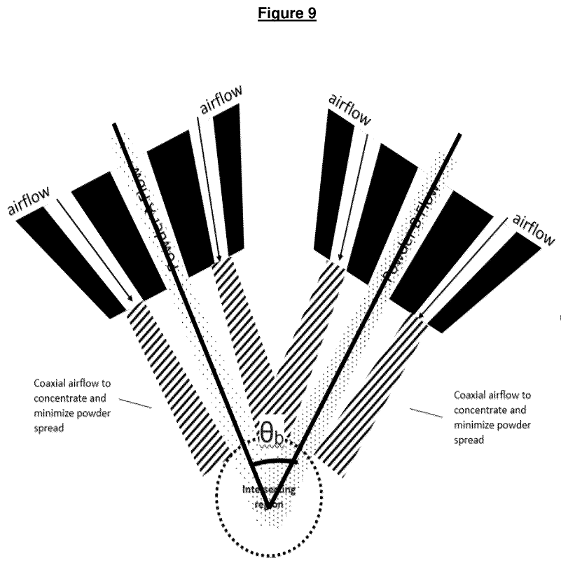

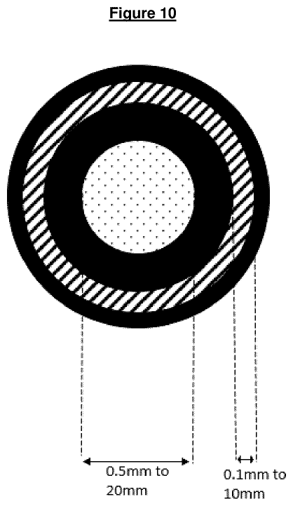

Another example of a nozzle is as shown in FIG. 9, and the cross-section of the nozzle is shown in FIG. 10. Two channels for flowing metal powder were arranged between an inlet and an outlet. The two channels were angled in a converging manner towards the outlet. Powder A flowed through one channel while Powder B flowed through the other channel.

A coaxial airflow channel surrounding the channel for Powder A, and another coaxial airflow channel surrounding the channel for Powder B, were formed. Argon was flowed through the airflow channels at 1 L/min.

Powders A and B converged within the plasma at an angle of 0°>θ_{b}>180° to form an alloy, and the airflow minimised powder spread.

Whilst the foregoing description has described exemplary embodiments, it will be understood by those skilled in the technology concerned that many variations may be made without departing from the present invention.

1. A method for producing a spheroidized powder from a feed stream comprising metal powder, the method comprising:
feeding a first feed stream comprising metal powder into a plasma chamber at a first angle offset from plasma flow within the plasma chamber; and
melting and spheroidizing the metal powder within the plasma chamber to form spheroidized powder,
wherein the first angle offset from plasma flow is in a direction against the plasma flow.

2. The method according to claim 1, further comprising feeding a second feed stream comprising metal powder into the plasma chamber at a second angle offset from plasma flow within the plasma chamber, prior to the melting and spheroidizing.

3. The method according to claim 1, wherein the first angle is 0° to 90° relative to plasma flow.

4. The method according to claim 2, wherein the second angle is 0° to 90° relative to plasma flow.

5. The method according to claim 1, comprising simultaneously providing at least one coaxial airflow respective to a flow of the metal powder with the feeding a first feed stream and/or feeding a second feed stream.

6. The method according to claim 1, comprising sequentially providing at least one coaxial airflow respective to a flow of the metal powder with the feeding a first feed stream and/or feeding a second feed stream.

7. The method according to claim 1, wherein the metal powder comprised in the first feed stream is the same or different from the metal powder comprised in the second feed stream.

8. The method according to claim 1, wherein the feeding a first feed stream comprises flowing the metal powder in a plurality of metal powder streams.

9. The method according to claim 8, wherein each of the plurality of metal powder streams comprises a different type of metal powder.

10. The method according to claim 8, wherein the flowing comprises converging each of the plurality of metal powder streams at an angle between 0° to 90° in the plasma chamber.

11. The method according to claim 2, wherein the feeding a second feed stream comprises flowing the metal powder in a plurality of metal powder streams.

12. The method according to claim 11, wherein each of the plurality of metal powder streams comprises a different type of metal powder.

13. The method according to claim 11, wherein the flowing comprises converging each of the plurality of metal powder streams at an angle between 0° to 180° in the plasma.

14. (canceled)

15. The method according to claim 1, wherein the spheroidized powder comprise a particle diameter of 20-500 μm.

16. The method according to claim 2, wherein the second angle offset from plasma flow is in a direction against the plasma flow.

17. A nozzle for feeding a feed stream into a plasma chamber, the nozzle comprising:
an inlet adapted to receive a metal powder;
an outlet adapted to feed the metal powder into a plasma chamber; and
a plurality of channels between the inlet and the outlet, adapted to flow the metal powder from the inlet to the outlet,
wherein the plurality of channels are arranged at a converging angle towards the outlet.

18. The nozzle according to claim 17, further comprising at least one airflow channel surrounding the plurality of channels.

19. The nozzle according to claim 18, wherein the at least one airflow channel is arranged coaxially relative to the plurality of channels.

20. The nozzle according to claim 17, wherein the converging angle is between 0° to 90° relative to each of the plurality of channels.

21. The nozzle according to claim 18, further comprising at least one airflow channel arranged between the plurality of channels.

22-24. (canceled)
